(19) United States
(12) Patent Application Publication
(10) Pub. No.: US 2016/0187585 A1
(43) Pub. Date: Jun. 30, 2016

(54) OPTICAL FITLER SUBASSEMBLY FOR COMPACT WAVELENGTH DEMULTIPLEXING DEVICE

(71) Applicant: XUEFENG YUE, San Jose, CA (US)

(72) Inventor: XUEFENG YUE, San Jose, CA (US)

(21) Appl. No.: 14/852,542

(22) Filed: Sep. 12, 2015

Related U.S. Application Data
(63) Continuation of application No. 62/098,996, filed on Dec. 31, 2014.

(51) Int. Cl. G02B 6/293; H04J 14/02

(52) U.S. Cl. CPC G02B 6/2938; H04J 14/02

(57) ABSTRACT

In the field of fiber optic communication, Wavelength Division Multiplexing (WDM) devices are used to combine wavelengths of light onto a single strand of fiber. To construct a WDM device, the optical components such as mirrors and filters must be cut in precise angles and positioned in parallel orientations to separate or combine wavelengths of light. The expenditure for implementation of free-space WDM devices can be prodigiously high and costly for compact devices. Techniques for designing optical components to manufacture a compact free-space WDM device including a surface mount assembly are disclosed. In addition to the common optical components used in a WDM device, a hybrid subassembly is included to assist in the orientation of optical components when manufacturing the compact device.

### REFERENCE TO RELATED APPLICATION

The present application claims priority to the provisional Appl. Ser. No. 62/098,996 filed on Dec. 31, 2014, the entire content of which is hereby incorporated by reference.

### FIELD OF THE INVENTION

The present invention generally relates to the field of fiber optic communications. More particularly, the invention relates to integrated subassemblies for Wavelength Division Multiplexing (WDM) and demultplexing devices including improvements in optical layout design and manufacturing processes to achieve compact WDM assemblies.

### BACKGROUND OF THE INVENTION

Wavelength Division Multiplexing (WDM) is one of the most important devices in optical communications. It involves a method of combining multiple signals on lasers beams at various infrared wavelengths for transmission on to fiber optic media. Laser modulation controls a set of signal channels and each infrared channel carries several radio frequency signals using a method called time division multiplexing. With time division multiplexing (TDM) the signals are transmitted and received over a common signal path using synchronized switches at the end of the transmission line. Each signal appears on the line for only a fraction of time. The multiplexed infrared channels are separated into the original signal at the destined fiber strand.

Using TDM in the infrared (IR) channels, the signals that carry data can be transmitted at the same time on a single fiber. The concept of WDM was first published in the 1970s and development on fiber optics signal transmission with WDM systems was limited to two IR channels per fiber. At the end of the fiber line the IR channels were separated or demultiplexed by a two wavelength filter. The cutoff wavelength was approximately halfway between the wavelengths of the two channels. As the fiber optic technology advanced, more than two multiplexed IR channels could be demultiplexed using cascaded dichroic filters. This gave rise to the coarse wavelength-division multiplexing (CWDM) and dense wavelength-division multiplexing (DWDM). DWDM devices use tightly spaced wavelengths in the range of 1450 to 1650 nanometers while CWDM devices use broader spaced wavelengths over the full range of 1280 to 1650 nanometers (a full range of single more fiber). Overall WDM, DWDM, and CWDM devices are based on the similar concept of using multiple wavelengths of light on a single fiber. The difference between them is the spacing of wavelengths, number of channels, and the ability to amplify the multiplexed signals in the optical space.

Furthermore, a three-port WDM device is commonly used in the industry and convenient to describe the process of increasing the capacity of a single strand of optical fiber. In a WDM system, many different colors of light are combined by a WDM multiplexing device and placed into a single strand of fiber while each color is called a channel. Conversely on the receiving side, each color is separated to have its own channel by using a WDM demultiplexing device. Thin film filters (TTF) are used to pass and reflect the desired wavelengths of light. A collimator can be placed before the thin film filter to collimate the light to prevent a large and uncontrolled beam. With three fiber strands on the same side of the three port WDM device, the first fiber may carry three wavelengths of light on a single strand of fiber. As light passes through the first fiber and incident on to the thin film filters, certain wavelengths are reflected onto a second fiber or a third fiber. Some wavelengths will pass through the filters and be placed onto a fiber on the opposite side of the filters. Furthermore, TTF-based WDMs can be cascaded to obtain higher channel counts including 4, 8, 16, and 32 channels. However, for multi-channel WDMs more space is required in a device due to the fiber routing and higher loss due to multiple times of coupling between the free-space and the fiber.

Additionally, in order to produce a compact WDM device, a free space multi-port technology is used which involves the thin film filters, individual fiber collimators or collimators set up in arrays, with the addition of mirrors to reflect light. The fibers are aligned in parallel and come from the same side of the WDM device similar to a three-port WDM device. Along with the fibers, the filters need to be placed in parallel to the mirror in order to keep all the filters in line to achieve the same angle of incidence (AOI).

In this type of assembly the mirror and filters are mounted to the same base plate component in a compact device, where side mount is needed. In this case, the filters and the mirror must have a very accurate cutting angle in order for the filter surface to be parallel to the mirror surface. The angle between the coating surface and cutting surface must be well controlled. Yet, the filters that can be used for side mount are expensive. Thus, what is needed is a surface-mount method technology using a novel subassembly design to arrange the optical components to fit in a compact free-space WDM device.

### SUMMARY OF THE INVENTION

The present invention brings forth a subassembly device to achieve surface mount for filters and mirrors in an orientation to fit in a compact free-space WDM device. A mechanical mount part can be machined and used as the subassembly optical member when constructing a free-space device. However, by machining the subassembly optical member, the flatness and parallelism has extremely tight tolerances that may be difficult to achieve. With the addition of a glass mounting block subassembly to assist in constructing the compact device, a tight control of alignment and parallelism for the filters and mirror surface can be achieved as well. Among the components in a WDM device, the filters, mirrors, and the subassembly can be used by adding small diameter collimators to lead the light beam into the filters in the compact device. The free-space mounting glass material subassembly is also included to assist in the manufacturing of a compact WDM device by making the physical length of the device shorter. All optical components can be assembled in the same plane while all components may also be assembled in layers to make the device more compact and save space.

With the inclusion of the glass mounting block hybrid subassembly, the surfaces used for filter mount and mirror mount are parallel, and the coefficient of thermal expansion (CTE) of the hybrid subassembly is similar to the other optical components in the assembly. In addition, all components are attached using epoxy glue and fiber rods are used as spacer between two surfaces made of glass. A prism can be oriented in different positions to turn light 180 degrees which also assists in shortening the physical length of the device. The input wavelengths and output wavelengths pass in a parallel direction.

Other objects, features, and advantages of the present invention will become apparent upon examining the following detailed description of an embodiment thereof, taken in conjunction with the attached drawings.

### BRIEF DESCRIPTION OF THE DRAWINGS

FIG. 1 is a top view illustration with prisms, mirrors, and filters in a specific orientation required for creating a free-space WDM device mounted to a metal surface. The directional arrows indicate the path of a beam of light passing through the optical components.

FIG. 2 is an illustration of the design of a free-space mounting subassembly to be used in conjunction with the optical components of FIG. 1. With the guidance of the mounting subassembly, the optical components will be conveniently positioned in the correct arrangement.

FIG. 3 is an illustration of an integrated subassembly comprising optical components arranged in the same plane within a free-space compact WDM device.

FIG. 4 is an illustration of an integrated subassembly comprising optical components arranged in a different orientation. The prism is turned 90 degrees in comparison to the orientation of the FIG. 3 illustration, thus the input layer is above the output layer to pack the optical components and save space in a compact device.

FIG. 5 is a hybrid assembly with a right angle prism turned 90 degrees as also shown in FIG. 4. The channel separation in a WDM is closer than the channel separation of a CWDM and a glass mounting block subassembly is used in place of a non-transparent mechanical block that must be emptied inside to let optical signal pass through.

FIG. 6 is an illustration of the hybrid subassembly with a glass block as the various surfaces are indicated with anti-reflection coating and high-reflectivity coating.

FIG. 7 is an illustration of the hybrid subassembly. A geometrical equation to calculate the arc sin angle of the glass block to make the input and output collimators parallel is discussed.

FIG. 8 is an illustration of a further compacted WDM assembly. In this illustration the light from the input layer is below the output layer for space saving and the prisms stretches along the length of the glass block optical component.

FIG. 9 is an illustration of hybrid subassembly along with other optical components used to construct a compact free-space WDM device. In this illustration the addition of fiber rods are shown to be used as spacers between optical components to realize epoxy free optical path.

FIG. 10 is an illustration of an exploded view of FIG. 9. The fiber rods and spacers are shown for the benefit of clarity to allow an epoxy free optical path.

### DETAILED DESCRIPTION OF THE DRAWINGS

While the present invention may be embodied in different, forms, designs, or configurations, for the purpose of presenting an understanding of the principles of the invention, references will be made to the embodiments illustrated in the diagrams and drawings. Specific language will be used to describe the embodiments. Nevertheless it is intended to show that no limitation or restriction of the scope of the invention is thereby intended. Any alterations and further implementations of the principles of this invention as described herein are as they would normally occur to one skilled in the art to which the invention relates.

FIG. 1 is a top view of a free-space mounting subassembly including several optical components comprising a compact WDM device mounted to a metal mounting block. Prism 102 is attached to one side of the subassembly 101. As light enters the prism an anti-reflective coating surface on the subassembly shown in 106 allows light to pass through the prism and light turns 180 degrees as shown in the directional arrows in the figure such that the input fiber link and output fiber links are in the same direction. Light passes through a thin film filter 103 at each output link. Each filter has an anti-reflective coating surface 108 which is parallel to the subassembly surface. The thin film filters can reflect and refract wavelengths of light as indicated in the directional path of light 109 shown in the figure. Another surface with high reflectivity coating 107 is on the opposite side and parallel to the filters 103. A mirror 104 is mounted behind this high-reflectivity coating surface to reflect light back into other fiber strands. Prism 102 and mirror 104 are positioned on the same side as shown in FIG. 1. In this configuration, the filters 103 and mirror 104 are parallel to allow light to reflect from the mirror thus allowing light to pass through the center of each filter and on to a strand of optical fiber. Each component in the assembly is mounted using an epoxy glue with no epoxy glue in the optical path. The mounting subassembly component is made of a glass substrate material or metal with a coefficient of thermal expansion similar to the filter and mirror material. As each component may expand and contract during operation with heat dissipating by light and electricity inside the compact device, the alignment of the components should remain in place.

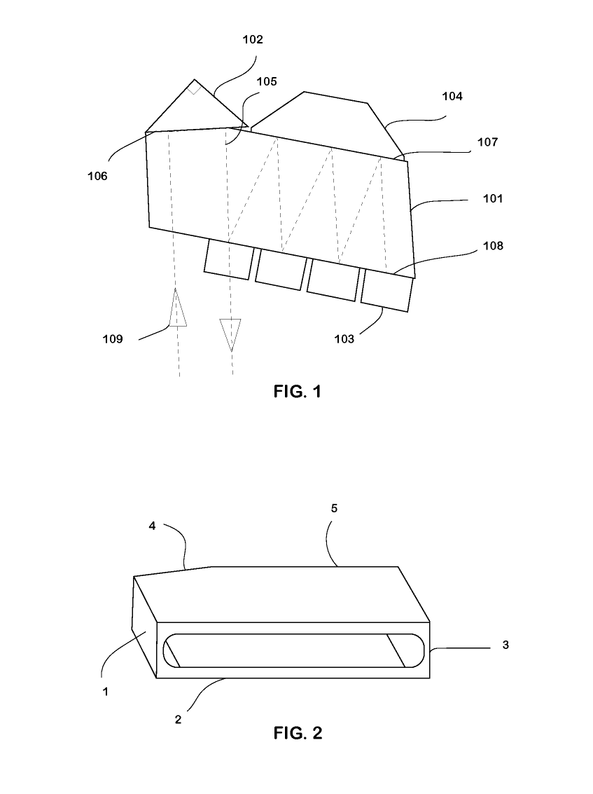

FIG. 2 is a 3-dimensional view of a free-space mounting subassembly. In this view the novel design of the subassembly is presented and the shape can be described in more detail. The subassembly has five external surfaces 1, 2, 3, 4, 5 while the surface 4 is cut at a 90 degree angle. As described in the previous figure a front prism is mounted on to the surface 4, a mirror is mounted on to the surface 5, and filters are mounted onto the surface 2. Assuming the designed angle of incidence (AOI) of the filter is alpha, and then the angle between the mirror and the front prism is 180 degrees less than alpha. An extruded cut through the entire subassembly is featured to allow a light beam to pass through the subassembly and run a course to perform the multiplexing.

FIG. 3 is a top view for an integration of an optical subassembly in a WDM device. A flat surface base member allows all the optical components to be mounted on the same plane. Multiple collimators 301 are positioned in a parallel array along the same plane of a base member 303. The subassembly featured in FIG. 2 and FIG. 3 is also positioned along the flat surface of the base member 303 and the thin film filters 304 are positioned between the collimators 301 and subassembly. With the addition of the optical subassembly to assist in positioning the optical components, the two parallel surfaces 305 allow a mirror 306 and the thin film filters 304 to be mounted in an orientation for the light beam to pass through the prism 307, perform multiplexing, and place wavelengths of light into separate fiber strands. The optical subassembly also assists in the compact configuration of positioning the optical components to produce a compact WDM device. However, in the layout as illustrated in FIG. 3, the integrated configuration of the device is fully functional and yet still wide as more space is used to lay out the components in the same plane.

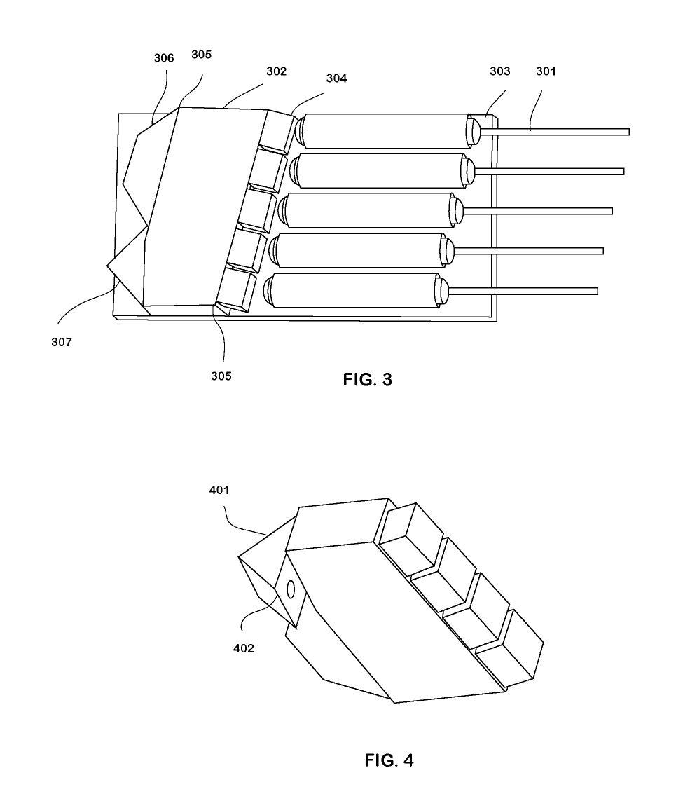

FIG. 4 is an illustration of another type of orientation for the assembly of optical components in a compact WDM device. In an effort to make the WDM device more compact, the right angle prism 401 is also presented in previous figures can be rotated 90 degrees to reduce the width of the assembly shown in FIG. 3. In this type of configuration, the collimators will be positioned in two layers as the input light beam will pass through a collimator on a top row, while all output collimators will receive light through a bottom row. In this illustration the mounting block material is metal. The operation is identical as to the previous configuration illustrated in FIG. 3 as the two angled surfaces of the prism 401 will turn light beams 180 degrees from the top layer collimator and down into the bottom row of collimators to perform the same multiplexing operation. The prism 401 also has the same anti-reflective coating 402 along the flat hypotenuse surface mounted to the subassembly.

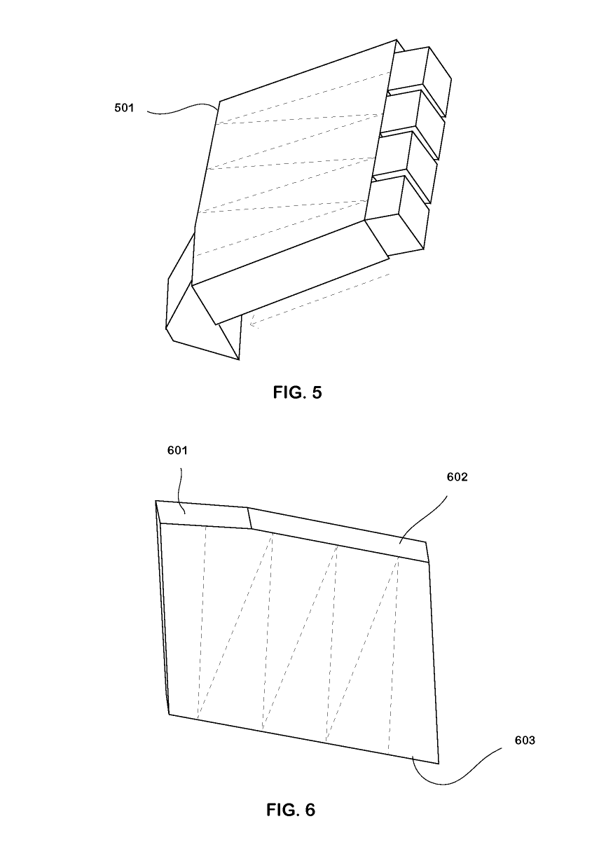

FIG. 5 is an illustration of a hybrid subassembly as shown in FIG. 4 along with other optical components mounted to perform multiplexing in a compact WDM device. In the present embodiment, the hybrid subassembly 501 is a metal machined to achieve the desired angles and flatness. For a CWDM device, the machine tolerances are adequate and the channel separation for wavelengths is wider than a typical WDM device. For a WDM device, a dose channel separation requires the glass-mounting block to be made of a glass material with finer flatness in order to achieve parallelism. As described in the previous figures, the mirror and filters are positioned parallel to one another in a precise orientation to reflect light beams into separate fiber links. Tolerances are less with a glass substrate which allows filters and the mirror to align accurately.

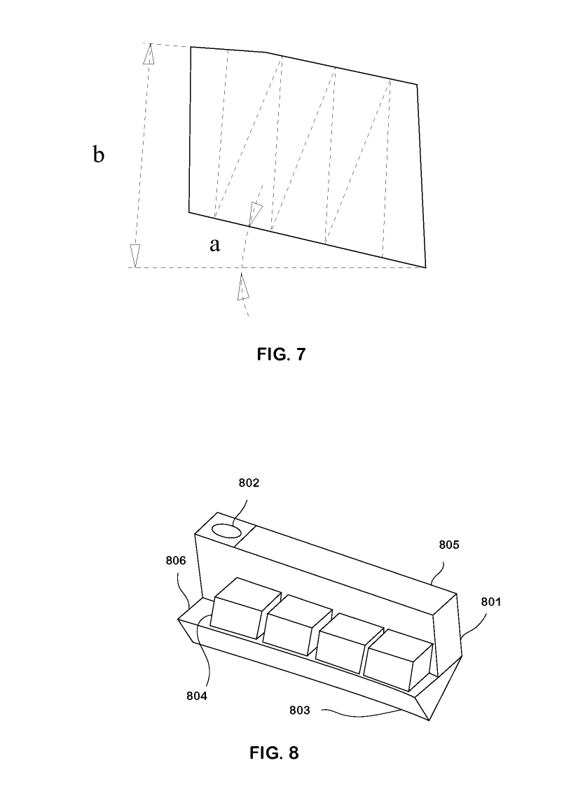

FIGS. 6 and 7 are rotated views of FIG. 1. In FIG. 6 the surfaces on the hybrid subassembly coated with anti-reflection coating and high reflectivity coating are presented for clarity. The hybrid subassembly is a glass block material with polished surfaces on both sides. In FIG. 6, the anti-reflective coating allows a light beam to pass through the surfaces and bend 180 degrees as a prism (not shown) is mounted on this surface. The physical length of the WDM device is shortened as the light beam takes a sharp turn and travels to another anti-reflective surface 603 on the opposite side of the prisms. Mounted to the anti-reflective surface of 603 are filters (not shown) that can reflect light beam or allow light beam to pass through collimators and onto optical fiber strands (not shown). The reflected light beams travel back to a high reflectivity surface shown in 602 while a mirror (not shown) is positioned behind the highly reflective surface to reflect all light back on to other filters. The filters and mirror are positioned in parallel. In FIG. 7 the angle alpha is the cut angle of the glass block. Beta is the angle cut for the surface to mount for the prism (not shown). A mathematical relationship between Beta and alpha is used to make the input and output collimators (not shown) parallel. The equation is as follows:

B=α−sin⁻¹(sin α/ng)

where ng is the refractive index of glass material.

When the optical components are mounted to the hybrid subassembly in the desired positions, each component is mechanically secured with epoxy and the configuration of optical components ensures the multiplexing process in a compact WDM device.

FIG. 8 is another view of a hybrid subassembly with optical components mounted to make WDM device even more compact. The glass block 801 is reconfigured and in this orientation the light from the first collimator (not shown) in one layer of the assembly enters the area of the glass block 801 with anti-reflection coating 802, light is reflected two times by the prism's 803 two angled surfaces. Again the prism 803 is rotated 90 degrees to save space and the hypotenuse side of the prism 803 is mounted against a surface of the glass block 801 using epoxy glue. The hypotenuse surface of the prism 803 has an anti-reflection coating 806 such that when light from the input collimator passes through the glass block 801 and through the prisms 803, the surface of the anti-reflective coating 806 allows light to pass through and travel to the thin film filters 804. The reflected light from the first thin film filter 804 goes back and is reflected twice before finally hitting the back surface 805 of the glass block 801 which has a high reflectivity coating applied to reflect all light. The high reflectivity coating reflects light back to the second thin film filter 804 and the third thin film filter 804. Each of the collimators (not shown) on the receiving end are positioned in line with the thin film filters 804 to collimate light before the light goes into an optical fiber strand. The thin film filters 804 need to be parallel to the back side of the glass block 801 with high reflectivity coating to create the same AOI for light incident on all thin film filters 804. Furthermore, the glass block 801 again has a cut angle for the prism 803 to be positioned in accordance to the filters.

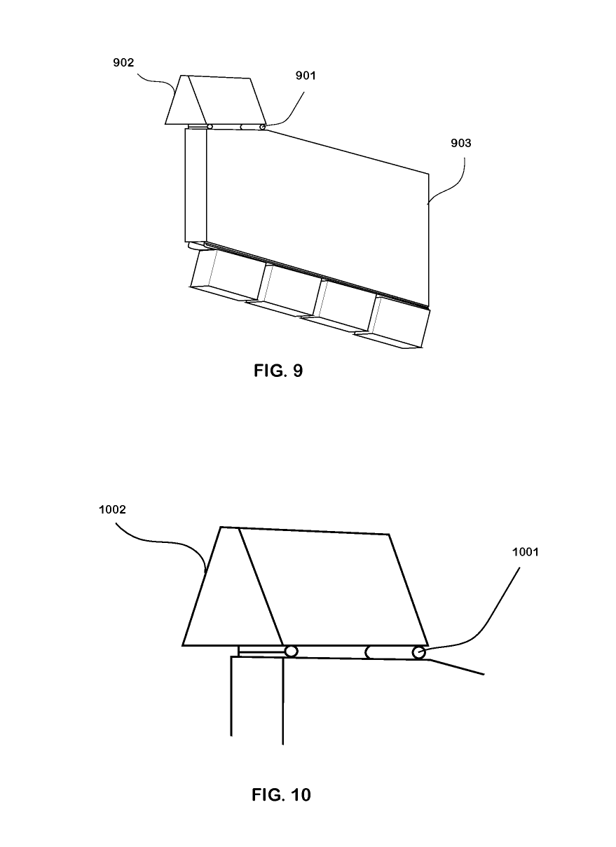

FIGS. 9 and 10 are illustrations of a hybrid subassembly that focuses on the method of assembling optical components to a glass block 903. It is preferred that no epoxy is used in the optical path of the light beam when optical components are mounted to the glass block 903. If the optical components are directly attached to the glass block 903, the epoxy glue may spread across the surface areas and impede in the optical light path. Therefore, a fiber rod 901 is used as a spacer between the optical components between the first prism 902 and the glass block 903, hence a fiber rod 901 as a spacer is used to provide a buffer. The fiber rod 901 is cut directly from standard fiber and ideally has a diameter of 125 micrometers.

In FIG. 10, an enlarged view of the fiber rod 1001 is shown for the benefit of clarity. In the enlarged view, the fiber rod 1001 is positioned at the edge of the prism 1002 and is glued to the hybrid subassembly to realize an epoxy free optical path for the light beam. Also by using a fiber rod 1001 as a spacer to connect the optical components to the subassembly, the epoxy will only be limited to the surface of the fiber rod 1001 and the majority of the optical path of the light beam will be epoxy free.

Although one or more embodiments of the newly improved invention have been described in detail, one of ordinary skill in the art will appreciate the modifications to the material selection, design of the hybrid subassembly and configuration of optical components. It is acknowledged that obvious modifications will ensue to a person skilled in the art. The claims which follow will set out the full scope of the claims.

1. An optical assembly having a multiplexer mode and a demultiplexer mode, comprising:
an optical base;
a reflection element set placed on the optical base for reflecting light beams exiting the optical base back to the optical base; and
a plurality of optical filters placed on the optical base;
wherein at least one light beam passes through either the reflection element set or the optical filter, enters the optical base, undergoes reflections within the optical base, scatters/converges and then exits the optical assembly.

2. The optical assembly of claim 1, further comprising:
a plurality of light beam transceivers for receiving and transmitting the light beams;
for the demultiplexer mode, the light beam transceiver emits the light beam to enter the optical base and then the reflection element set, undergoes reflections in the reflection element set and then enters the optical base, undergoes reflections within the optical base and scatter into a plurality of the light beams with different wavelengths, and then all exits the optical assembly through the optical filters,
for the multiplexer mode, the light beam transceivers emit a plurality of the light beams with different wavelengths to pass through the optical filters and enter the optical base, undergo reflections within the optical base and then enter the reflection element set, undergo reflections in the reflection element set and then exit the optical assembly along one common path.

3. The optical assembly of claim 2, wherein the light beam transceivers are arranged to be substantially parallel.

4. The optical assembly of claim 1, wherein the reflection element set includes a mirror and a reflection coating.

5. The optical assembly of claim 1, wherein the reflection element set includes a light beam port for light beams to pass through,
for the demultiplexing mode, the light beam transceiver emits the light beam to enter the reflection element set through the light beam port, undergoes reflections in the reflection element set, enters the optical base, undergoes reflections in the optical base and scatters into a plurality of light beams with different wavelengths, and exits the optical assembly through the optical filters,
for the multiplexing mode, the light beam transceivers emit a plurality of the light beams with different wavelengths to pass through the optical filters, enter the optical base, undergo reflections in the optical base, exit the optical base and enter the reflection element set, undergo reflections in the reflection element set and eventually exit the reflection element set along a common path through the light beam port.

6. The optical assembly of claim 1, further comprising at least one optical spacer placed on the optical base and between the reflection element set and the optical base, wherein the optical spacer includes an optical fiber.

7. The optical assembly of claim 1, wherein the optical base includes a light beam port,
for the demultiplexer mode, the light beam enters the optical base through the light beam port, exits the optical base and enters the reflection element set, undergoes reflections in the reflection element set and scatters into a plurality of the light beams with different wavelengths, exits the reflection element set, and travels toward the optical filters,
for the multiplexer mode, a plurality of the light beams with different wavelengths enters the reflection element set through the optical filters, undergo reflections in the reflection element set and enter the optical base, undergo further reflections in the optical base and exits the optical assembly through the light beam port along a common path.

8. The optical assembly of claim 1, further comprising an anti-reflection layer placed on the optical base for allowing the light beam to pass through, wherein the anti-reflection layer is located between the optical base and the reflection element set or between the optical base and the optical filters.

9. The optical assembly of claim 1 further comprising a base plate, wherein the optical base, the reflection element set, and the optical filters are placed on the base plate.

10. A method of manufacturing an optical assembly having a multiplexer mode and a demultiplexer mode, comprising steps of:
placing at least one reflection element set and a plurality of optical filters on an optical base;
generating at least one light beam to pass through either the reflection element set or the optical filter to enters the optical base, undergoes reflections within the optical base, scatters/converges and eventually exit the optical assembly.

11. The method of claim 10, comprising:
relaying a plurality of the light beams with a plurality of light beam transceiver;
for the demultiplexer mode, directing the light to enter the optical base and then the reflection element set, undergo reflections in the reflection element set and then enter the optical base, undergo reflections within the optical base and scatter into a plurality of the light beams with different wavelengths, and then all exit the optical assembly through the optical filters,
for the multiplexer mode, directing a plurality of the light beams with different wavelengths to pass through the optical filters and enter the optical base, undergo reflections reflection within the optical base and then enter the reflection element set, undergo reflections in the reflection element set and exit the optical assembly along one common path.

12. The method of claim 11, further comprising arranging the light beam transceivers to be substantially parallel.

13. The method of claim 10, wherein the reflection element set includes a mirror and a reflection coating.

14. The method of claim 10, further comprising:
forming a light beam port on the reflection element set for accepting the light beams;
for the demultiplexing mode, directing the light beam to enter the reflection element set through the light beam port, undergo reflections in the reflection element set, enter the optical base, undergo reflections in the optical base and scatter, and exit the optical assembly through the optical filters; and
for the multiplexing mode, directing a plurality of the light beams with different wavelengths to pass through the optical filters, enter the optical base, undergo reflections in the optical base, exit the optical base and enter the reflection element set, undergo reflections in the reflection element set and eventually exit the reflection element set along a common path.

15. The method of claim 10, further comprising placing at least one optical spacer on the optical base and in between the reflection element set and the optical base, wherein the optical spacer includes an optical fiber.

16. The method of claim 10, further comprising:
forming a light beam port on the optical base for accepting the light beams;
for the demultiplexing mode, directing the light beam to enter the optical base through the light beam ports, exit the optical base and enter the reflection element set, undergo reflection in the reflection element set and scatter into a plurality of the light beams with different wavelengths, exit the reflection element set, and exits through the optical filters,
for the multiplexing mode, directing a plurality of the light beams with different wavelengths to enter the reflection element set through the optical filters, undergo reflections in the reflection element set and enter the optical base, undergo further reflections in the optical base and exits the optical assembly through the light beam port along a common path.

17. The method of claim 10, further comprising placing an anti-reflection layer on the optical base for the light beam to pass through, wherein the anti-reflection layer is located between the optical base and the reflection element set or between the optical base and the optical filters.

18. The method of claim 10, further comprising placing the optical base, the reflection element set, and the optical filters are placed on a base plate.

19. A communication system, comprising:
a light signal generator for generating at least one light beam;
a plurality of light beam transceivers for receiving and transmitting the light beams;
and
an optical assembly for receiving the light beams from the light beam transceivers, including:
a optical base;
at least one reflection element set placed on the optical base; and
a plurality of optical filters placed on the optical base;
wherein at least one of the light beams passes through either the reflection element set or the optical filter, enters the optical base, undergoes reflections within the optical base, and eventually exits the optical assembly.

20. The communication system of claim 19, wherein the optical assembly further
includes a demultiplexer mode and a multiplexer mode,
for the demultiplexer mode, the light beam enters the optical base, passes through the anti-reflection layer and enters the reflection element set, undergoes reflections in the reflection element set, passes through the anti-reflection coating and enters the optical base, undergoes reflections within the optical base and breaks down into a plurality of the light beams with different wavelengths, and then all exits the optical assembly through the optical filters,
for the multiplexer mode, a plurality of the light beams with different wavelengths pass through the optical filters and enter the optical base, undergo reflections reflection within the optical base, pass through the anti-reflection layer and enter the reflection element set, undergo reflections in the reflection element set and exit the optical assembly along one common path.
